(19) United States
(12) Patent Application Publication
(10) Pub. No.: US 2018/0043205 A1
(43) Pub. Date: Feb. 15, 2018

(54) Interactive Exercise Mat

(71) Applicant: Q Holdings LLC, New York, NY (US)

(72) Inventor: Molly Duffy, San Francisco, CA (US)

(73) Assignee: Q Holdings LLC, New York, NY (US)

(21) Appl. No.: 14/617,641

(22) Filed: Feb. 9, 2015

Related U.S. Application Data
(60) Provisional application No. 61/937,261, filed on Feb. 7, 2014.

(51) Int. Cl. A63B 21/00; A63B 71/06; B32B 27/06; B32B 5/02; B32B 5/18

(52) U.S. Cl. CPC A63B 21/4037; B32B 5/022; B32B 5/18; B32B 27/065; A63B 71/0622; B32B 2262/0276; B32B 2262/062; A63B 2220/56

(57) ABSTRACT

An interactive exercise mat that provides a user a visual feedback through illumination of a lighting means based on the position of a user's body parts on the mat is provided. The mat includes a top, outer layer, a first protective layer, a lighting layer comprising lighting means, wherein the lighting layer can be embedded within the protective layer or disposed beneath the protective layer, a second protective layer, a pressure sensing element, a base layer and an electronic control element.

### CROSS-REFERENCE TO RELATED APPLICATIONS

This Application claims priority to U.S. Provisional Patent Application No. 61/937,261 filed Feb. 7, 2014, which is incorporated herein by reference in its entirety.

### FIELD OF THE INVENTION

The present invention is directed to an exercise mat, more particularly to an exercise mat comprising interactive, electronic visual feedback displays.

### BACKGROUND OF THE INVENTION

Yoga and similar types of physical exercise involve the practice of a variety of body postures and poses. There are over 1000 yoga poses, and many require a stable foundation, extreme balance and proper positional alignment. Most commonly, yoga is practiced on a mat, with the stable foundation being provided by the users placement of particular body parts on parts of the mat.

The use of a substantially flexible, resilient mat for purposes of exercise is well known, and such mats are typically formed from a spongy, or rubber-like, substance. Mats of varying shapes and sizes are well known including, for example, the mats used by gymnasts, freestyle and Greco-Roman wrestlers, and even the relatively smaller, usually rectangular mats often used by young children at “nap time” at pre-schools and kindergarten. Many individuals use such mats as part of the equipment for personal exercise and training.

Due to the complexities of many yoga poses, and the rise of home yoga practice without an instructor, many yoga practitioners may perform yoga poses incorrectly without knowledge of the mistakes in their pose. Accordingly, there is a need for a yoga mat that can provide visual and, optionally, audio feedback directly on the mat to a user.

### SUMMARY OF THE INVENTION

A first embodiment of the present invention includes a mat comprising a top, outer layer, a first protective layer, a lighting layer comprising lighting means, wherein the lighting layer can be embedded within the protective layer or disposed beneath the protective layer, a second protective layer, a pressure sensing element, a base layer and an electronic control element.

In use, the mat, via the pressure sensing element, can detect the placement of various body parts in relation to a given pose, and the mat will provide feedback by way of illuminated lights and/or audio cues to correct, adjust or teach a given pose. The illuminated lights can direct the user where on the mat to place a particular body part.

A second embodiment of the present invention includes a method for practicing yoga comprising providing visual feedback cues via illuminated lighting in the mat to the user.

### DETAILED DESCRIPTION OF THE INVENTION

The embodiments of the present invention are described below with reference to the following description and drawings of an exercise mat with integrated visual feedback displays.

The mat comprises a plurality of layers disposed upon one another, and connected to an electronic control element. In a preferred embodiment, the mat comprises a top, outer layer disposed on a first protective layer. A lighting means is disposed either within the first protective layer or directly underneath the protective layer. Below the lighting means is a second protective layer, which comprises a pressure sensor or a plurality of pressure sensors. The bottom layer of the mat comprises a base layer.

The top, outer layer is made of a suitable material which can help the exercise mat hold its shape, provide cushioning, provide flexibility, or provide support, or any combination thereof; or a material that bonds well with other layers; or any combination thereof. The top layer may be made of PVC foam; polyurethane; another suitable flexible material such as a woven or non woven polyester/polyurethane blend fabric made with nano fibers; or micro fibers with wicking properties; thermoplastic elastomer (IPE); natural rubber; synthetic rubber; or any combination thereof.

Preferably, the top, outer layer is transparent or translucent. Most preferably, the top, outer layer is transparent.

In one embodiment, the top layer may be 0.2 to 5 millimeters thick, although this may vary in other embodiments to achieve different flexibility or cushioning requirements for the mat. The top, outer layer may provide a level of friction that gives sufficient grip (e.g., in wet and/or dry conditions) to a user without restricting the user's movement.

The first protective layer provides structural integrity and cushioning for the mat, and can also provide a medium for the lighting means. The first protective layer may be made of, for example: a non-woven polyester cotton blended fabric; a polyester/cotton blend; a woven or non woven fabric made of either 100% cotton or 1.00% polyester or a blend of cotton and polyester; thermoplastic elastomers; a polyvinyl chloride; polyurethane; a foam material made of natural rubber, synthetic rubber, or nylon spandex, or any combination thereof; a suitable material which can help the exercise mat hold its shape, provide a suitable medium for the lighting means, provide cushioning, provide flexibility, or provide support, or any combination thereof; or a material that bonds well with other exercise mat layers; or any combination thereof. In some embodiments of the invention, the first protective layer may be 0.2-20 millimeters thick, although this may vary in other embodiments with different flexibility or cushioning requirements for the exercise mat. The first protective layer is preferably transparent or translucent, more preferably, it is transparent.

The lighting means can be disposed either within the first protective layer, or underneath said layer, and, when illuminated, shines through the top outer layer and is visible by the mat's user. The lighting means preferably includes a plurality of light emitting diodes (LED). Preferably, the LED range in size from 5 nanometers to 10 centimeters, more preferably 1 millimeter to 1 centimeter, most preferably from 5 millimeters to 50 millimeters. The LED can be any color, including blue, white, red, green, purple, yellow, or other suitable color. Additionally, the LED can be any suitable voltage. The lighting means also comprises a power source, which can be direct or alternating current, or battery-powered.

The second protective layer provides structural integrity and cushioning for the mat, and can also provide a medium for the pressure sensor or plurality of pressure sensors. The second protective layer may be made of, for example: a non-woven polyester cotton blended fabric; a 50% polyester 50% cotton blend; a woven or non woven fabric made of either 100% cotton or 100% polyester or a blend of cotton and polyester; thermoplastic elastomers; a polyvinyl chloride; polyurethane; a foam material made of natural rubber, synthetic rubber, or nylon spandex, or any combination thereof; a suitable material which can help the exercise mat hold its shape, provide a suitable medium for the lighting means, provide cushioning, provide flexibility, or provide support, or any combination thereof; or a material that bonds well with other exercise mat layers; or any combination thereof, in some embodiments of the invention, the second protective layer may be 0.2-20 millimeters thick, although this may vary in other embodiments with different flexibility or cushioning requirements for the exercise mat.

The pressure sensing element can be arranged as a plurality of pressure sensors or as a single pressure sensor. Any pressure sensor capable of transmitting the pressure information to an electronic control element can be used.

The base layer can provide friction and/or traction (e.g., in wet and/or dry conditions), so that when it is placed in contact with a floor by a user, the exercise mat does not slide when the user utilizes the exercise mat (e.g., for yoga or another exercise). The base layer can also provide cushioning for the user. In some embodiments, the bottom layer may be provided with a textured surface to enhance grip. The base layer may be made of a thermoplastic elastomer, polyvinyl chloride, polyurethane, natural rubber, synthetic rubber or another material which provides cushioning and/or grip, or any combination thereof. In other embodiments, the base layer may be made of rubber, including natural rubber, synthetic rubber, or a blend of the two, or mix of natural rubber, synthetic rubber and thermoplastic elastomers as well as the above-mentioned materials, or any combination thereof. In some embodiments, the base layer may also be made of a suitable material which can help the exercise mat hold its shape, provide cushioning, provide flexibility, provide wear and tear resistance, or provide support, or any combination thereof; or a material that bonds well with other exercise mat layers; or any combination thereof. The base layer may also be perforated to allow moisture to pass through and for quick drying of the mat. (It should be noted that any layers described herein may also be perforated.) In one embodiment, the base layer may be 1.5 to 25 millimeters thick, preferably 3 to 10 millimeters thick, although this may vary in other embodiments with different flexibility or cushioning requirements for the mat.

The mat further comprises an electronic control element. The electronic control element is integrally connected to the lighting means and the pressure sensing element. Typically, a plurality of wiring elements are located within the mat element between the first protective layer and the second protective layer connecting the plurality of pressure sensing elements and/or lighting means to the electronic control element. Similarly, the electronic control element is typically located at one end of the mat, but can also be located on either side, if the mat is rectangular in shape. Additionally, while the preferred embodiment shows that the control element is in communication electrically with the plurality of pressure sensing elements through the plurality of wiring elements, the communication may also be wireless as well, such as but not limited to radio frequency signals for example.

As one of the plurality of pressure sensing elements is activated, a signal is sent to the control element which in turn provides a response to the lighting means. However, the response may also be feedback comprising but not limited to a sound, a light, music, audible words, a vibration, and the like, or any combination thereof, without affecting the overall scope of the invention. The mat further comprises a speaker element connected to the electronic control element to provide audible feedback stored in the electronic control element. For example, as the user activates one of the plurality of pressure sensing elements, the speaker element may emit a stored recorded sound or noise. Additionally, the control element comprises a power source, preferably a battery or an external electrical plug in cord.

The various layers described above may be bonded to one another using any suitable bonding technique. In one embodiment, the layers may have thermoplastic bonding properties that cause adjacent layers to bond with one another when heated. In a heat bonding process, liquid polyurethane may be cured on non woven fabric and rubber may be vulcanized on the other side of the non woven fabric at or near, for example, 180 degrees Celsius. In another bonding process, liquid polyurethane may be cured on non woven fabric and a thermoplastic elastomer may be glued to the other side of the non woven fabric with a non toluene lamination adhesive (e.g., a non-toluene lamination adhesive, such as but not limited to 635NT) and/or other suitable adhesive. Alternatively, layers may be bonded using other adhesives and/or mechanical connections. In addition, any combination of these methods or any other method may be utilized.

### BRIEF DESCRIPTION OF THE DRAWINGS

FIG. 1 shows an embodiment of a mat assembly.

FIG. 2 shows an exploded view of an embodiment of a mat assembly.

FIG. 3 shows an exploded view of an embodiment of an electronic control element.

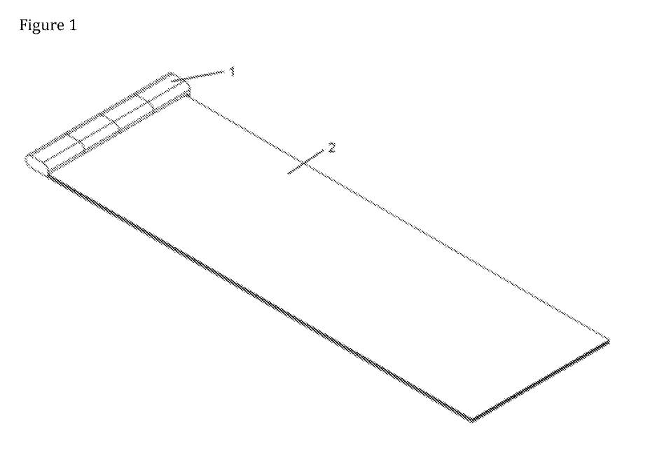

Referring to FIG. 1, there is a shown mat 2 having an electronic control element 1 attached at an end (e.g., top end or bottom end) of the mat assembly. While the electronic control element 1 is illustrated at an end of the assembly (e.g, mat 2), such a location is not intended to be limiting. Rather, in other possible examples, the electronic control element 1 may be positioned along one or more of the other sides of the mat 2. Further still, the electronic control element 1 may not be directly attached/connected to the mat 2, and, instead, may be housed/stored at remote/detached/separate location from the mat 2.

In further detail, still referring to FIG. 1, the mat 2 is sufficiently long enough to allow for users of nearly any size (e.g., for example, average size users, children, large adults, etc.) to feel comfortable practicing yoga or performing other exercises on the mat. The mat 2 comprises any number of dimensions. In the illustrated example, the mat 2 has a generally quadrilateral (e.g., rectangular) shape. The mat 2 is not so limited, however, and in other examples, may include other quadrilateral shapes (e.g., squares, etc.), non-quadrilateral shapes (e.g., circular shapes, ovoid shapes, triangular shapes, etc.), or the like.

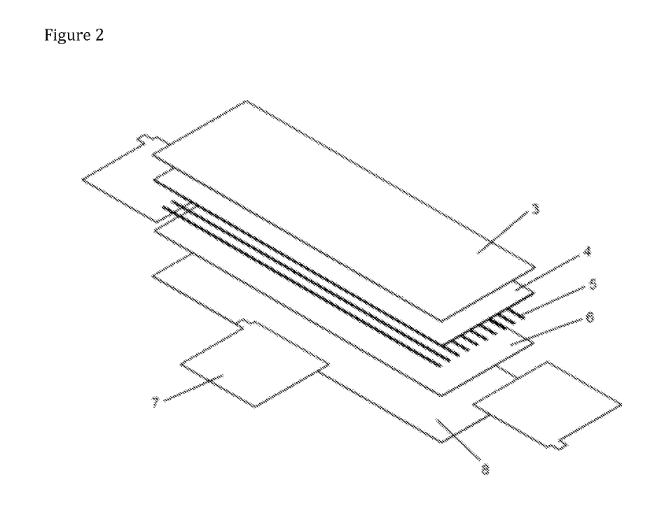

Referring now to FIG. 2, there is shown an exploded view of the mat with a top, outer layer 3, a first protective layer 4 with an embedded lighting layer 5, a second protective layer 6 that houses a pressure sensor 7, and a base layer 8. The construction details illustrated in FIG. 2 are that the top, outer layer 3 may be made of PVC foam or any other material transparent enough for the lighting layer to shine through and soft enough for user comfort. In some possible examples, the top, outer layer 3 may include a plastic or polymer material that allows for at least some degree of transparency to allow for light to shine through and/or be visible to a user. The top, outer layer 3 may also include a material that enhances grip between a user and the top, outer layer 3, to reduce the likelihood of slipping.

The first protective layer 4 may be positioned adjacent and underneath the top layer 3. The protective layer 4 can be attached with respect to the top, outer layer 3, such that the top, outer layer 3 and protective layer 4 are generally fixed/immovable with respect to each other. The first protective layer 4 should be made of a stiff enough material so that the lighting layer 5 cannot be felt underfoot.

In an example, the protective layer 4 allows for at least some degree of transparency to allow for light to shine through and/or to be visible to the user. In some examples, the first protective layer 4 has a size and shape that generally matches the size/shape of the top layer 3, however, the protective layer 4 is not so limited. Indeed, the top layer 3 and protective layer 4 may have differing sizes/shapes.

The lighting means 5 can be provided as embedded or as a layer that is adjacent and underneath the protective layer 4. In one possible example, the lighting means 5 can be attached with respect to the protective layer 4 such that the lighting layer 5 and protective layer 4 are generally fixed/immovable with respect to each other. The lighting means 5 can include one or more lights (e.g., LEDs, for example) that can selectively be illuminated to provide light through the first protective layer 4 and top, outer layer 3. The lights of the lighting means 5 can be arranged in any number of ways. For example, the lights of the lighting means 5 can be arranged in a grid or matrix-like fashion. In the illustrated example, the lights are arranged in generally linear rows, though the lighting layer 5 is not so limited.

The second protective layer 6 can be provided adjacent and underneath the lighting layer 5.

This protective layer can be generally identical in size and shape as the protective layer 4 described above. This layer 6 can provide protection for the pressure sensing layer 7 from potentially damaging factors such as moisture or shear stresses, and may allow the pressure sensing layer to be removed. The second protective layer 6 need not be transparent if it is located below the lighting layer 5. The pressure sensing layer 7 can be provided inside the protective layer 6 and underneath the lighting layer 5, and can consist of a variety of pressure sensing configurations. For example, the pressure sensing layer may be made of a single pressure mapping sensor sheet, a combination of smaller pressure mapping sensor sheets, or a grid of individual pressure sensors.

The base layer 8 can be provided adjacent and underneath the second protective layer 6 and/or the pressure sensing layer 7. The bottom layer 8 can be generally identical in size, shape, structure, and/or construction as the top, outer layer 3 described above. The bottom layer 8 may also be constructed of a different material than the top layer 3 to provide sufficient traction with a surface so that the mat does not move while in use.

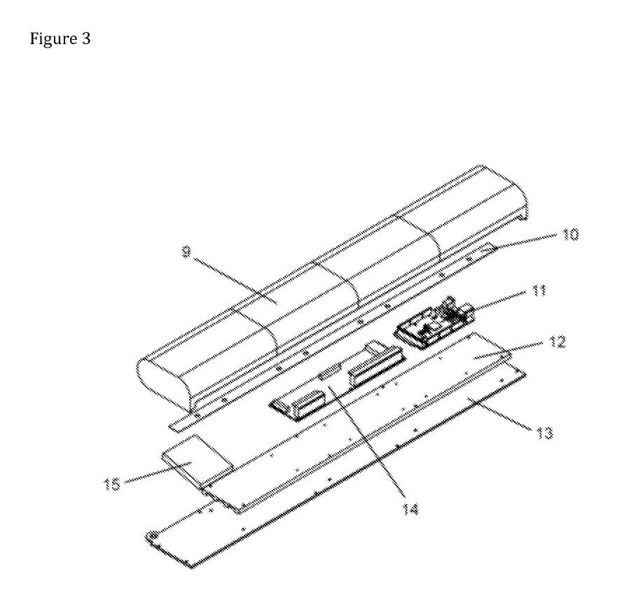

The multiple layers can be joined and sealed by various methods to form a single mat. These methods may allow for disassembly and removal of individual layers. As an example, the pressure sensing element 7 can be made removable for cleaning, maintenance, or any other reasons. The layers may also be rearranged and combined in any configuration. As an example, the lighting layer 5 and pressure sensing element 7 may be combined to form a single layer. As another example, the lighting layer 5 and pressure sensing element 7 may also be separated into two distinct mats that can be used either separately or in conjunction with each other. Referring now to FIG. 3, the cover for the electronic control element 9 serves as a cosmetic housing and as protection for the electronics inside. One end can have a series of openings/ports that allow the electronics to interface with other components.

A thin strip 10 on the inner surface of the cover provides locating features for the lamination process and additional support for the cover. A microcontroller 11 is housed within the electronic control element near one end. The microcontroller 11 can store memory and interfaces with outside devices (e.g. computer, tablet, cell phone, television).

A clamp 12 can be a slotted board that pins the mat against the baseplate 13 to hold it firmly. The baseplate 13 can interface with the clamp to secure the enclosure to the mat. The clamp 12 or the baseplate 13 may provide mounting features for the other components of the enclosure 1 or holes from which the system can be hung.

A printed circuit board 14 of control and measurement electronics can also be housed inside the electronic control element to allow for exchange of information between the mat and the microcontroller. A pressure sensor connector 15 can serve as a connection between the flexible pressure sensing element within the mat itself and the electronics inside the enclosure.

While using the mat, a user can chose to perform a single pose or a series a poses through an interactive platform on a mobile device or laptop computer. The mat can communicate with the user's device, via the electronic control element, through a variety of methods (e.g., USB port or Bluetooth, for example).

When in use, the lighting means in the mat will operate in conjunction with the pressure sensing layer via electronic control element and/or an interactive platform to illuminate the lights areas of the mat where a user's body part should be placed in order to achieve proper positioning for a given pose. The electronic control element may also provide auditory feedback in addition to the visual feedback provided by the lighting element.

Accordingly, another embodiment of the present invention involves a method for practicing yoga comprising providing an exercise mat described herein, sensing the position of a user's body parts with a pressure sensing element, and illuminating a lighting means based on placement of the user's body parts on the mat.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the features and aspects of the interactive exercise mats described above can be used in various combinations.

We claim:

1. An interactive exercise mat comprising a top, outer layer, a first protective layer, a lighting means, a second protective layer, a plurality of pressure sensors, a base layer, and an electronic control element.

2. The interactive exercise mat according to claim 1 wherein the lighting means is embedded within the first protective layer or is located directly beneath the first protective layer.

3. The interactive exercise mat according to claim 1 wherein the pressure sensors are embedded within the second protective layer or are located directly beneath the second protective layer.

4. The interactive exercise mat according to claim 1 wherein the top, outer layer is transparent.

5. The interactive exercise mat according to claim 4 wherein the first protective layer is transparent.

6. The interactive exercise mat according to claim 1 wherein the top, outer layer comprises a material selected from the group consisting of PVC foam, polyurethane, a woven or non-woven polyester/polyurethane blend fabric comprising nano fibers, a natural rubber, a synthetic rubber, and a thermoplastic elastomer, and combinations thereof.

7. The interactive exercise mat according to claim 1 wherein the top layer is between about 0.2 to 5 millimeters thick.

8. The interactive exercise mat according to claim 1 wherein the first protective layer comprises a material selected from the group consisting of a non-woven polyester cotton blended fabric; a polyester/cotton blend; a woven or non woven fabric made of either 100% cotton or 100% polyester or a blend of cotton and polyester; thermoplastic elastomers; a polyvinyl chloride; polyurethane; a foam material made of natural rubber, synthetic rubber, or nylon spandex, and combinations thereof.

9. The interactive exercise mat according to claim 1 wherein the first protective layer is between about 0.2-20 millimeters thick.

10. The interactive exercise mat according to claim 1 wherein the lighting means comprise a plurality of light emitting diodes (LED's).

11. The interactive exercise mat according to claim 10 wherein the LED's are between 5 nanometers to 50 millimeters.

12. The interactive exercise mat according to claim 1 wherein the electronic control element is integrally connected to the lighting means and the pressure sensing element.

13. The interactive exercise mat according to claim 1 wherein the mat can communicate with a computing device through an interactive platform.

14. A method for practicing yoga comprising providing an exercise mat according to claim 1, sensing a position of a user's body parts on the mat with a pressure sensing element, and illuminating a lighting means based on placement of the user's body parts on the mat.
